(19) United States
(12) Patent Application Publication
(10) Pub. No.: US 2002/0102143 A1
(43) Pub. Date: Aug. 1, 2002

(54) Ratchet mechanism of rotating tool

(76) Inventor: Chin-Tan Huang, Ta-Li City (TW)

Correspondence Address: ROSENBERG, KLEIN & LEE, 3458 ELLICOTT CENTER DRIVE - SUITE 101, ELLICOTT CITY, MD, 21043, US

(21) Appl. No.: 09/769,431

(22) Filed: Jan. 26, 2001

(51) Int. Cl. B25B 15/04; F16D 41/00

(52) U.S. Cl. 408/241 R; 192/43; 81/63.1

(57) ABSTRACT

A ratchet mechanism of rotating tool including a hollow sleeve fitted in a seat body. A toothed disc is fitted on the sleeve and two movable blocks are respectively fitted with two ends of the sleeve. The movable blocks have toothed sections and are pushed by resilient members to engage with ratchet faces of the toothed disc. A hoop is rotably fitted around the toothed disc. The movable blocks abut against two end faces of the hoop. Each of the end faces has a slope face and each movable block has a projecting block corresponding thereto. When the hoop is rotated, the slope face pushes the projecting block so as to move the movable blocks, whereby the toothed sections of the movable blocks are disengaged from the ratchet faces of the toothed disc or engaged therewith.

### BACKGROUND OF THE INVENTION

The present invention is related to a ratchet mechanism of rotating tool, in which the toothed sections of movable blocks are engaged with the ratchet faces of the toothed disc on the entire circumferential face. In addition, the toothed sections of the movable blocks can be truly disengaged from the ratchet faces of the toothed disc or engaged therewith.

FIG. 6 shows a conventional ratchet mechanism including a seat body 81 and a casing 87 fitted around the seat body 81. A tool stem 82 is fitted in the seat body 81. One end of the tool stem 82 in the seat body 81 is provided with a gear 83. A chuck plate 88 is disposed in the seat body 81 for locating the gear 83. Two stop plates 84, 85 are disposed in the seat body 81 for abutting against the gear 83. A switch 86 is laid on the seat body 81 for switching the stop plates 84 and 85 to alternately engage with the gear 83 for driving the tool stem 82 in different directions.

FIGS. 7 and 8 show another type of conventional ratchet mechanism including a hollow seat body 91 and a cap 90 fitted thereon. A hexagonal tool stem 92 is fitted in the seat body 91. A toothed disc 93 is fitted around the tool stem 92. Two movable blocks 94, 95 are respectively fitted on two sides of the toothed disc 93. The two movable blocks 94, 95 are respectively formed with two toothed sections 941, 951 for engaging with two ratchet faces 931, 932 of the toothed disc 93. Two springs 942, 952 are respectively disposed between the movable blocks 94, 95 and the seat body 91 and the cap 90 for pushing the movable blocks 94, 95 to engage with the toothed disc 93. A shift block 96 is arranged on the seat body 91. The shift block 96 has an extending post 961 inserted in the toothed disc 93. By means of shifting the shift block 96, the toothed block 93 is driven to engage with or disengage from the movable blocks 94, 95. The seat body 91 is sheathed in a casing 97. The shift block 96 has a projecting section 962 corresponding to a dent 971 of the casing 97. The projecting section 962 can be engaged in the dent 971 to locate the shift block 96 in a certain position for controlling the driving direction of the ratchet mechanism.

According to such structure of the above ratchet mechanism, the shift block 96 via the post 961 only acts on one side of the toothed disc 93. Accordingly, it often takes place that only one side of the toothed disc 93 is forced to make the toothed disc 93 deflect and clog. Moreover, after moving the shift block 96, the shift block 96 is located only by means of the engagement between the projecting section 962 and the dent 971. Under such circumstance, in use of the ratchet mechanism, the projecting section 962 of the shift block 96 is quite liable to disengage from the dent 971 due to shock or collision. This will unexpectedly change the driving direction of the ratchet mechanism.

### SUMMARY OF THE INVENTION

It is therefore a primary object of the present invention to provide a ratchet mechanism of rotating tool. A toothed disc is fitted on the sleeve and two movable blocks are respectively fitted with two ends of the sleeve. The movable blocks have toothed sections and are pushed by resilient members to engage with ratchet faces of the toothed disc. A hoop is rotatably fitted around the toothed disc. The movable blocks abut against two end faces of the hoop. Each of the end faces has a slope face and each movable block has a projecting block corresponding thereto. When the hoop is rotated the slope face pushes the projecting block so as to move the movable blocks, whereby the toothed sections of the movable blocks are truly disengaged from the ratchet faces of the toothed disc or engaged therewith.

It is a further object of the present invention to provide the above ratchet mechanism of rotating tool, in which the toothed sections of movable blocks are engaged with the ratchet faces of the toothed disc on the entire circumferential face so that the ratchet mechanism is able to bear greater torque.

The present invention can be best understood through the following description and accompanying drawings wherein:

### BRIEF DESCRIPTION OF THE DRAWINGS

FIG. 1 is a perspective assembled view of the present invention;

FIG. 2 is a perspective exploded view of the present invention;

FIG. 3 is a sectional view taken along line III-III of FIG. 1;

FIG. 4 is a sectional view taken along line IV-IV of FIG. 1;

FIG. 5 is a sectional view showing the use of the present invention;

FIG. 6 is a perspective exploded view of a conventional ratchet mechanism;

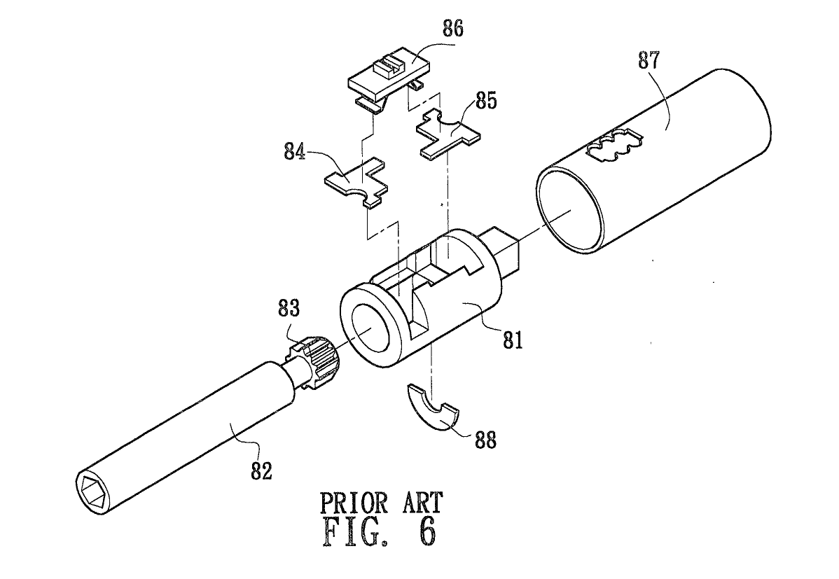

FIG. 7 is a plane view of another type of conventional ratchet mechanism; and

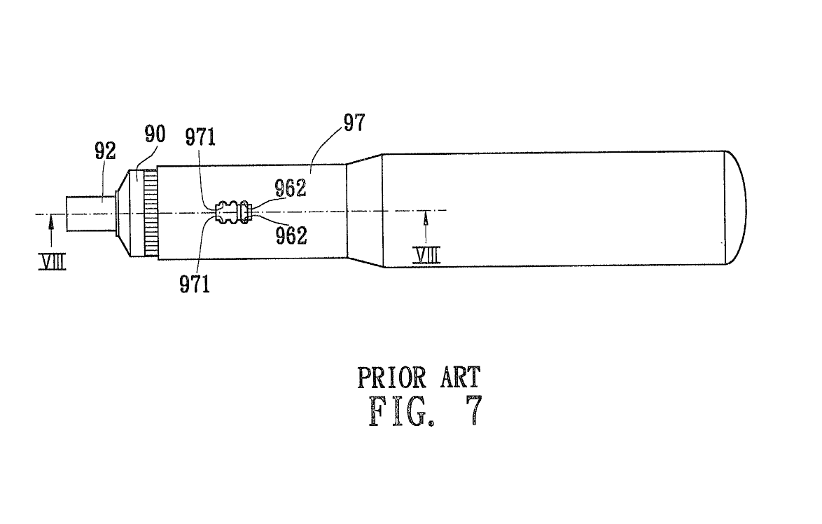

FIG. 8 is a sectional view taken along line VIII-VIII of FIG. 7.

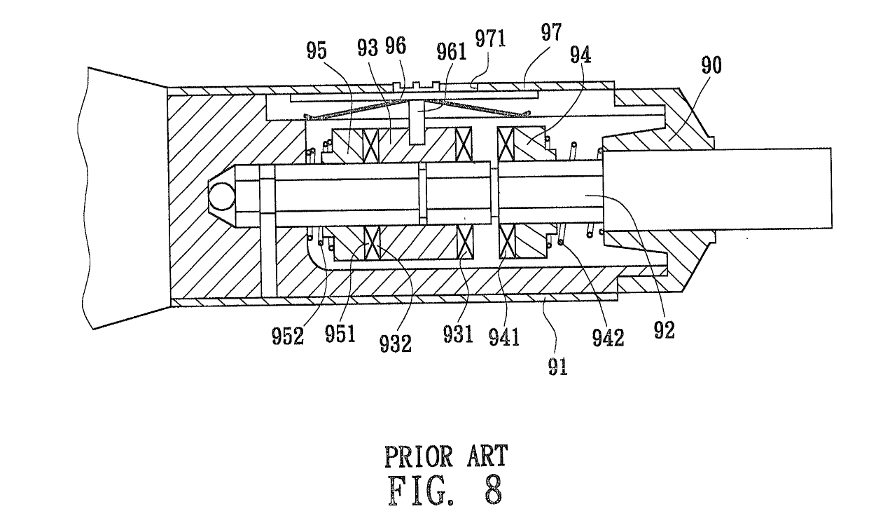

### DETAILED DESCRIPTION OF THE PREFERRED EMBODIMENT

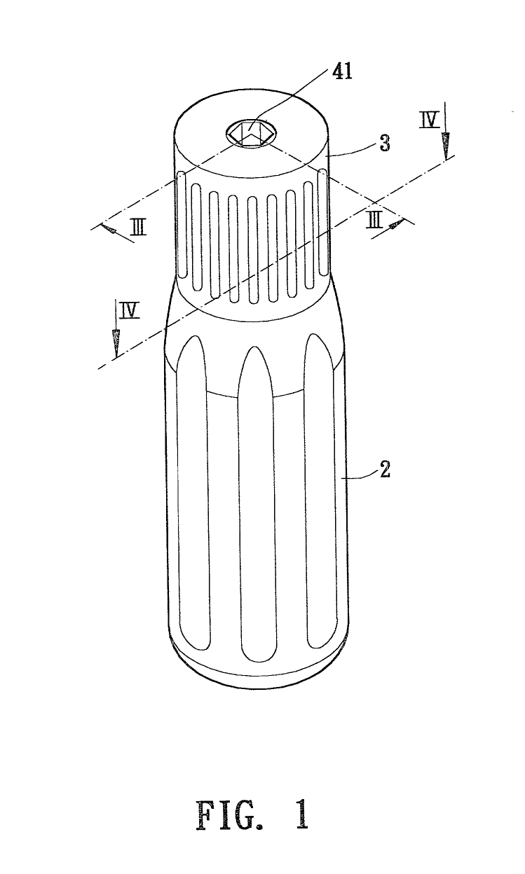

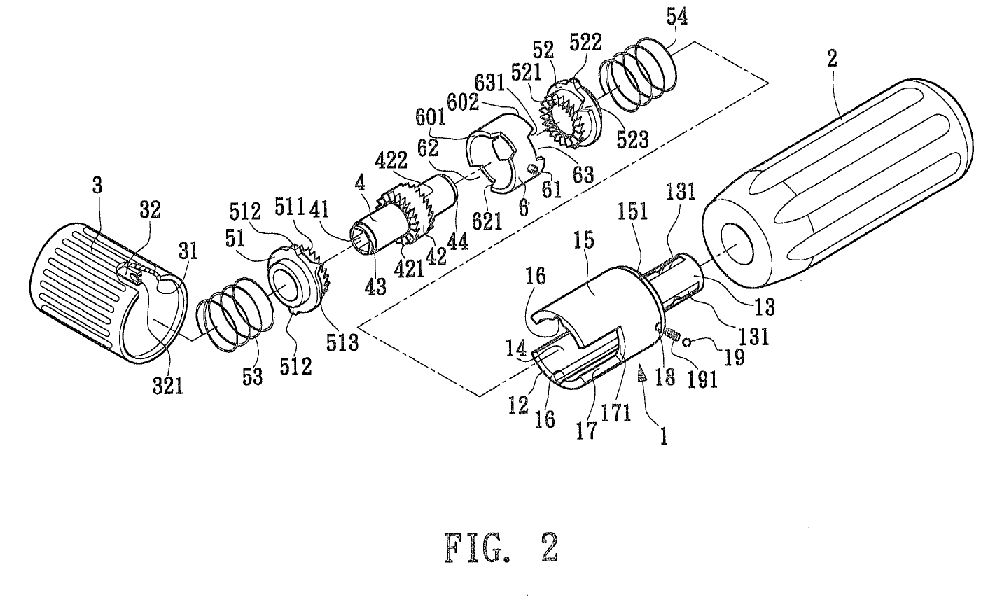

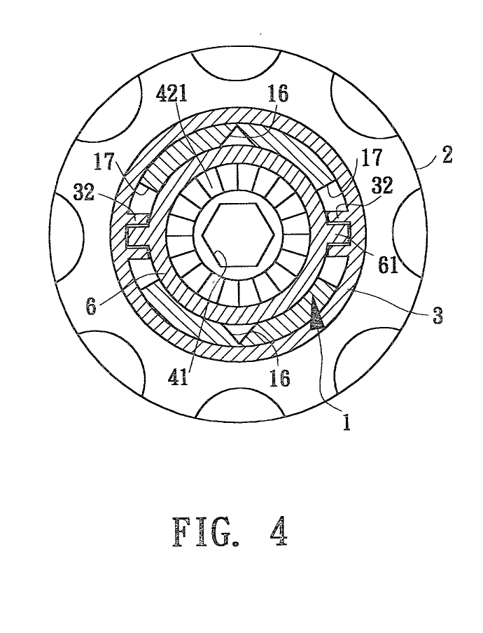

Please refer to FIGS. 1 to 4. The ratchet mechanism of rotating tool of the present invention includes:

a substantially cylindrical seat body 1 having a close end 11 and an open end 12, the close end 11 having an extending engaging section 13 formed with projecting ribs 131 which are inserted in a tool 2 and fixed therewith, the seat body 1 having an inner face 14 and an outer face 15, the inner face 14 being symmetrically formed with two axially extending channels 16, in addition, the seat body 1 being symmetrically formed with two cuts 17 extending from the open end 12 toward the close end 11, a bottom edge of each cut 17 being formed with an abutting face 171, the outer face 15 of the seat body 1 being formed with an annular groove 151 adjacent to the close end 11, the seat body 1 being further formed with a radial hole 18 in which a spring 191 and a steel ball 19 are sequentially disposed;

a cap 3 fitted around the seat body 1 from the open end 12 thereof and covering the seat body 1, the cap 3 being formed with a flange 31 corresponding to the annular groove 151 of the seat body 1, the flange 31 being engaged in the annular groove 151 for locating the cap 3 and restricting the cap 3 from axially displacing, the cap 3 being formed with a projecting engaging block 32 corresponding to each cut 17, the engaging block 32 having a width smaller than that of the cut 17, whereby the engaging block 32 is circumferentially movable within the cut 17, the cap 3 being further formed with multiple dents 33 corresponding to the steel ball 19 of the seat body 1 whereby after the cap 3 is rotated, the steel ball 19 is engaged in the dent 33 to locate the cap 3, the engaging block 32 being formed with a central engaging channel 321;

hollow sleeve 4 fitted in the seat body 1 between the close end 11 thereof and the cap 3, an interior of the sleeve 4 being formed with a tool connecting section 41, a middle section of the sleeve 4 being provided with a toothed disc 42, two end faces of the toothed disc 42 being respectively formed with two ratchet faces 421, 422 with different directions, two ends 43, 44 of the sleeve 4 being respectively engaged in a central recess 111 of the close end 11 of the seat body 1 and a central stepped hole 33 of the cap 3, whereby the sleeve 4 is restricted from axially displacing;

a first movable block 51 and a second movable block 52 respectively fitted around the sleeve 4 from two ends thereof, the first and second movable blocks 51, 52 being respectively formed with toothed sections 511, 521, two springs 53, 54 being respectively positioned between the first movable block 51 and the cap 3 and the second movable block 52 and the seat body 1, the springs 53, 54 serving to push the first and second movable blocks 51, 52 to make the toothed sections 511, 521 respectively engage with the ratchet faces 421, 422 of the toothed disc 42, the first and second movable blocks 51, 52 being respectively formed with two engaging blocks 512, 522 corresponding to the channels 16 of the seat body 1, the engaging blocks 512, 522 being engaged in the channels 16 to restrict the first and second movable blocks 51, 52 to only axially displace along the sleeve 4; and

a hoop 6 disposed in the seat body 1 and fitted around the toothed disc 42, the hoop 6 has two lugs 61 corresponding to the cuts 17 of the seat body 1 and movable therewithin, the lugs 61 respectively abutting against the engaging faces 171 of the cuts 17 and engaging in the engaging channels 321 of the engaging blocks 32, whereby when turning the cap 3, the hoop 6 is driven and rotated. The engaging channel 321 has a stop face 322 for pressing the lug 61 against the engaging face 171 of the cut 17. The stop face 322 and the engaging face 171 restrict the lug 61 from axially displacing, whereby the hoop 6 can be only rotated. The two springs 53, 54 resiliently force the first and second movable blocks 51, 52 to lean against two end faces 601, 602 of the hoop 6. Each of the end faces 601, 602 is formed with a notch 62, 63. Each of the notches 62, 63 has two lateral slope faces 621, 631. The first and second movable blocks 51, 52 respectively have two projecting blocks 513, 523 corresponding to the notches 62, 63. When rotating the hoop 6, the slope faces 621, 631 respectively push the projecting blocks 513, 523 to move the first and second movable blocks 51, 52, whereby the toothed sections 511, 521 thereof are engaged with or disengaged from the ratchet faces 421, 422 of the toothed disc 42.

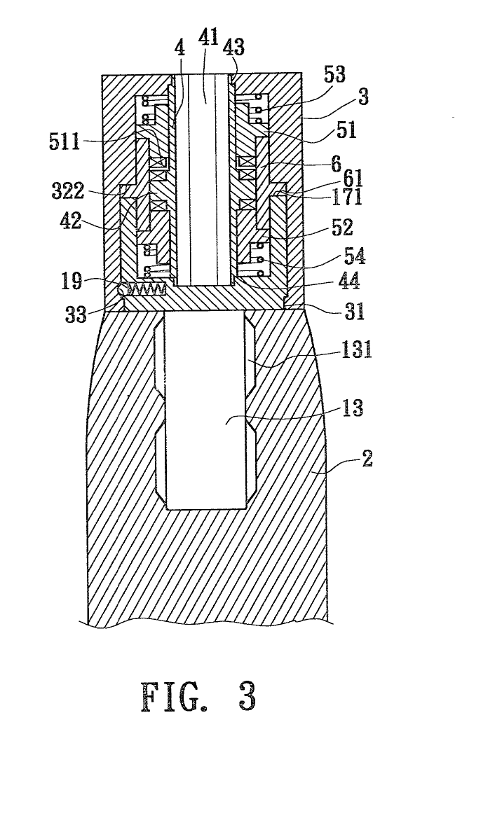

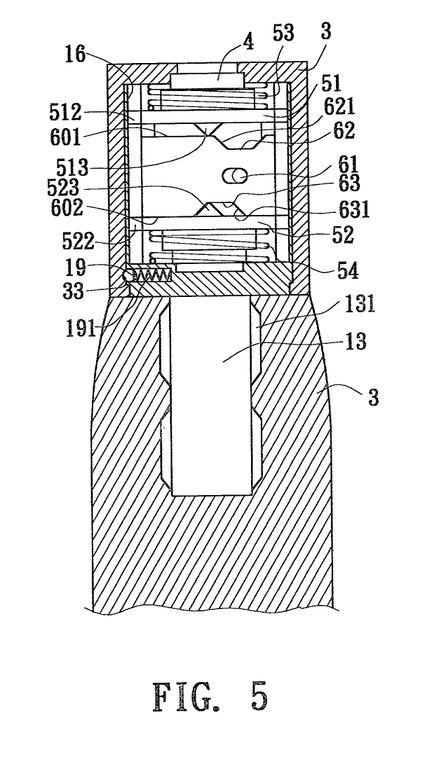

As shown in FIG. 5, when turning the cap 3, the hoop 6 is driven and rotated. At this time, the slope face 621 of the notch 62 of the hoop 6 will push the projecting block 513 of the first movable block 51. The engaging block 511 of the first movable block 51 is engaged in and restricted by the channel 16 so that the first movable block 51 can be only axially moved. Accordingly, the projecting block 513 will be pushed away along the slope face 621 to abut against the end face 601 of the hoop 6. At this time, the first movable block 51 is driven to separate from the toothed disc 42 and the toothed section 511 of the first movable block is truly disengaged from the ratchet face 421 of the toothed disc 42 as shown in FIG. 3. Accordingly, only the toothed section 521 of the second movable block 52 is engaged with the ratchet face 422 of the toothed disc 42. The engaging block 521 of the second movable block 52 is engaged in and restricted by the channel 16 so that the second movable block 52 is rotatable along with the seat body 1. Accordingly, when turning the tool 2, the second movable block 52 will drive the toothed disc 42 to rotate the sleeve 4. Similarly, in the case that the cap 3 is turned in a reverse direction, the first and second movable blocks 51, 52 will be engaged with the toothed disc 42 at the same time or the first movable block 51 is engaged with the toothed disc 42, while the second movable block 52 is disengaged from the toothed disc 42. Therefore, the direction in which the ratchet mechanism drives the sleeve 4 can be changed.

The toothed sections 511, 521 of the first and second movable blocks 51, 52 are engaged with the ratchet faces 421, 422 of the toothed disc 42 on the entire circumferential face so that the ratchet mechanism can bear greater torque.

The above embodiment is only used to illustrate the present invention, not intended to limit the scope thereof. Many modifications of the above embodiment can be made without departing from the spirit of the present invention.

What is claimed is:

1. A ratchet mechanism of rotating tool, comprising:
a substantially cylindrical seat body having a close end and an open end, the seat body having an inner face and an outer face, the inner face being formed with at least one axially extending channel, the seat body being further formed with at least one cut extending from the open end toward the close end;
a cap fitted around and covering the seat body, the cap being formed with a projecting engaging block corresponding to the cut, the engaging block having a width smaller than that of the cut, whereby the engaging block is circumferentially movable within the cut;
a hollow sleeve fitted in the seat body between the close end thereof and the cap, an interior of the sleeve being formed with a tool connecting section, a middle section of the sleeve being provided with a toothed disc, two end faces of the toothed disc being respectively formed with two ratchet faces with different directions;
two movable blocks respectively fitted around the sleeve from two ends thereof, the two movable blocks being respectively formed with two toothed sections, two resilient members being respectively positioned between the two movable blocks and the seat body and the cap, the resilient members serving to push the two movable blocks to make the toothed sections thereof respectively engage with the ratchet faces of the toothed disc, the two movable blocks being respectively formed with engaging blocks corresponding to the channels of the seat body, whereby the engaging blocks are engaged in the channels to restrict the two movable blocks to only axially displace along the sleeve; and
a hoop disposed in the seat body and fitted around the toothed disc, the resilient members resiliently forcing the two movable blocks to lean against two end faces of the hoop, the hoop having lugs corresponding to the cuts of the seat body and movable therewithin, the lugs being respectively engaged with the engaging blocks, whereby when turning the cap, the hoop is driven and rotated, each of the end faces of the hoop being formed with a slope face, each of the two movable blocks having a projecting block corresponding to the slope face, whereby when the hoop is rotated, the slope face pushes the projecting block to move the movable blocks so as to disengage the toothed sections thereof from the ratchet faces of the toothed disc.

2. A ratchet mechanism of rotating tool as claimed in claim 1, wherein the close end of the seat body has an extending engaging section which is inserted in a tool and fixed therewith.

3. A ratchet mechanism of rotating tool as claimed in claim 1, wherein the outer face of the seat body is formed with an annular groove adjacent to the close end, the seat body being further formed with a radial hole in which a spring and a steel ball are sequentially disposed, the cap being formed with a flange corresponding to the annular groove of the seat body, the flange being engaged in the annular groove for locating the cap and restricting the cap from axially displacing, the cap being further formed with multiple dents corresponding to the steel ball of the seat body, whereby after the cap is rotated, the steel ball is engaged in the dent to locate the cap.

4. A ratchet mechanism of rotating tool as claimed in claim 1, wherein the close end of the seat body is formed with a recess in which one end of the sleeve is stopped, the cap being formed with a central stepped hole in which the other end of the sleeve is stopped, whereby the sleeve is rotatably located between the seat body and the cap and restricted from axially displacing.

5. A ratchet mechanism of rotating tool as claimed in claim 1, wherein a bottom edge of each cut of the seat body is formed with an abutting face against which the lug of the hoop is leant, the engaging block of the cap being formed with an engaging channel for engaging and pressing the lug against the engaging face of the cut, the engaging channel and the engaging face restricting the lug from axially displacing, whereby the hoop can be only rotated.

6. A ratchet mechanism of rotating tool as claimed in claim 1, wherein each of the end faces of the hoop is formed with a notch corresponding to the projecting block of the movable block, each notch having two lateral slope faces for pushing the projecting block.
